(19) United States
(12) Patent Application Publication
(10) Pub. No.: US 2012/0169537 A1
(43) Pub. Date: Jul. 5, 2012

(54) METHOD AND APPARATUS FOR DETECTING POSITIONING SYSTEM ANTENNA CONNECTION CHANGE

(75) Inventor: Fedor Danilenko, Phoenix, AZ (US)

(73) Assignee: QUALCOMM Incorporated, San Diego, CA (US)

(21) Appl. No.: 13/098,058

(22) Filed: Apr. 29, 2011

Related U.S. Application Data
(60) Provisional application No. 61/329,851, filed on Apr. 30, 2010.

(51) Int. Cl. G01S 19/24; G01S 1/00

(52) U.S. Cl. 342/357.63; 342/386

(57) ABSTRACT

Through use of the method and circuits disclosed herein, connection and disconnection of positioning system antenna to a positioning system enabled mobile device is automatically detected. Upon detection of a connection or disconnection of the active positioning antenna, a low noise amplifier is disabled (or enabled) and the gain of the receive chain is readjusted.

### CLAIM OF PRIORITY UNDER 35 U.S.C. §119

The present application claims priority to provisional U.S. Application Ser. No. 61/329,851, filed Apr. 30, 2010, entitled “Detection of the Active GPS Antenna Insertion and Removal,” assigned to the assignee hereof and incorporated herein by reference.

### FIELD

The various embodiments described herein relate in general to circuits, systems, and methods for detecting the connection or disconnection of an active antenna from a radio system, and, more specifically, to circuits and methods for detecting the connection or removal of an active antenna from a radio system of the type having position location signal receiving capabilities.

### BACKGROUND

Devices having position location capabilities are becoming increasingly popular and of widespread use. Often, such position location capabilities employ satellite positioning system (SPS) capabilities, which typically includes a system of transmitters positioned to enable entities to determine their location on or above the earth, based, at least in part, on signals received from the transmitters.

Position location transmitters usually transmit a signal marked with a repeating pseudo-random noise (PN) code of a set number of chips and may be located on ground based control stations, user equipment, or space vehicles. For example, position location transmitters may be located on earth orbiting satellite vehicles (SVs). For instance, an SV in a constellation of Global Navigation Satellite System (GNSS) such as Global Positioning System (GPS), Galileo, Glonass, or Compass may transmit a signal marked with a PN code that is distinguishable from PN codes transmitted by other SVs in the constellation, for example, by using different PN codes for each satellite as in GPS or using the same code on different frequencies as in Glonass.

The techniques presented herein are not restricted to global systems (e.g., GNSS) for SPS. For example, the techniques provided herein may be used in various regional systems, such as, e.g., Quasi-Zenith Satellite System (QZSS) over Japan, Indian Regional Navigational Satellite System (IRNSS) over India, Beidou over China, and/or various augmentation systems (e.g., a satellite based augmentation system (SBAS)) that may be associated with or otherwise enabled for use with one or more global or regional navigation satellite systems.

By way of example, an SBAS may include an augmentation system(s) that provides integrity information, and differential corrections: e.g., Wide Area Augmentation System (WAAS), European Geostationary Navigation Overlay Service (EGNOS), Multi-functional Satellite Augmentation System (MSAS), GPS Aided Geo Augmented Navigation, and GPS and Geo Augmented Navigation system (GAGAN). Thus, as used herein an SPS may include any combination of one or more global and/or regional navigation satellite systems and/or augmentation systems, and SPS signals may include SPS, SPS-like, and/or other signals associated with such one or more SPS.

Positioning location systems may also use pseudolites or a combination of satellites and pseudolites. Pseudolites are ground-based transmitters that broadcast a PN code or other ranging code (similar to a GPS or CDMA cellular signal) modulated on an L-band (or other frequency) carrier signal, which may be synchronized with GPS time. Each such transmitter may be assigned a unique PN code to permit identification by a remote receiver. Pseudolites are useful in situations where signals from an orbiting satellite might be unavailable, such as in tunnels, mines, buildings, urban canyons or other enclosed areas. Another implementation of pseudolites is known as radio beacons. The term “satellite”, as used herein, is intended to include pseudolites, equivalents of pseudolites, and possibly others. The term “SPS signals,” as used herein, is intended to include SPS-like signals from pseudolites or equivalents of pseudolites.

Mobile devices now almost universally include position location capabilities. More specifically, they may include some kind of positioning system signal receiver. Usually related to GPS systems. Personal navigation devices (PNDs) having GPS capabilities are also becoming widespread. Most GPS devices include a GPS antenna built directly into the device. However, because the GPS signals may be weak in certain environments, many devices are equipped with a capability to attach, or insert, an external active antenna to the device to improve reception of the GPS signals. An active antenna has an amplifier associated with it to help improve the signal reception (e.g., GPS signal reception). An active GPS antenna is particularly useful in situations where the open sky exposure is limited, such as in a building, in foliage, urban, indoor, and noisy environments.

Some active GPS antennas have a low noise amplifier (LNA) and a Radio Frequency (RF) bandpass filter, and provide around 15-25 dB of gain, typically about 25 dB of gain, and with a good noise figure of about 1.2-1.8 dB, typically with a 1.5 dB noise figure. The other typical relevant characteristics of the active antennas are: output impedance about 50-200 ohms, typically 50 ohms, supply voltages of 3.5, 2.5 or 1.8 VDC, and typical current consumption of about 1 ma-7 ma, typical 5 mA that may be constant over the entire supply voltage range.

To address situations where the signal strength may be weak, whereas a weak signal may be considered below −160 dBm and a strong signal may be considered to be above −140 dBm, or inconsistent in vehicular applications, e.g. “car kits” having various functionalities have been introduced to enable position location capable devices to be used effectively in vehicles for navigation purposes. Car kits of the type applicable herein have active external antennas associated with them, or at least have a capability for the attachment of an active antenna.

In the normal operation of a GPS device, typically a gain adjustment is performed at the beginning of each GPS session. The gain adjustment is needed because the GPS signal strength varies depending on atmospheric conditions, on whether the mobile device is located indoors or outdoors, and on whether an active GPS antenna (such as in a car kit) is being used. The goal of the gain adjustment is to ensure that the amplitude of the digital baseband data stream lies within a predetermined range determined by the digital baseband GPS processor design.

However, while the GPS session is still in progress, if the mobile device attaches or disconnects from the active antenna, a significant change in the signal power level may result. This may cause the GPS session to suffer problems related to a gain misadjustment, and in some cases even cause the device to lose location signal tracking.

What is needed, therefore, is a circuit and methods for detecting the attachment or disconnection of an active antenna to a positioning system signal receiver and for protecting the receiver from some of the effects produced by the attachment or disconnection of the active antenna.

### SUMMARY

The methods, circuits, and devices disclosed herein detect connection or disconnection of an active GPS antenna to a mobile device. Various methods may be used to detect the connection or disconnection of the active antenna. In some embodiments, a mechanical switch may be used, a magnetic switch, or a proximity detector. In another embodiment the sensing of the current drawn is used to detect. As the active antenna is connected or disconnected, the mobile device detects this event by sensing the current drawn by the active antenna. The connection and disconnection events disable or enable the mobile device's own GPS LNA, and trigger the GPS gain adjustment to restore the digital baseband amplitude to a desired target level. One benefit of this method is that the GPS session is not inadvertently interrupted and the signal power is maintained. This improves the sensitivity and time to first fix of the GPS receiver.

Some embodiments described herein apply to car kits that can boost a GPS signal to a mobile device. In this embodiment, the boost in signal strength provided by the car kit when a mobile device is connected to an active antenna and the drop in signal strength of the signal when the mobile device is removed from the active antenna during a GPS session are compensated. This makes a connection or disconnection of the mobile device to or from the boosting car kit seamless; that is, the mobile device with such a feature will adjust its receive gain automatically on connection or disconnection. If this feature is absent, connection to a car kit may saturate the GPS receiver of the mobile device, leading to a loss of ability to demodulate the satellite signal, and the mobile device may need to reset or power-cycle in order to force it to perform the initial gain adjustment performed at the start-up of GPS receiver.

Thus, according to an embodiment of a GPS receiver, a circuit detects a connection change of an active antenna and a circuit adjusts a receiver gain to compensate for the connection change when a connection change is detected. The GPS receiver may include a signal path for a GPS signal from the active GPS antenna, and a low noise amplifier (LNA) in the signal path. When the circuit for detecting a connection change detects a disconnection of the active GPS antenna, the circuit for adjusting said receiver gain enables said LNA, and when the circuit for detecting a connection change detects a connection of the active GPS antenna, the circuit for adjusting said receiver gain disables the LNA.

In another embodiment the GPS receiver may also include a radio frequency integrated circuit (RFIC) including a programmable gain amplifier, wherein the adjustment to the receiver gain is an adjustment to a gain of programmable gain amplifier. The GPS receiver may also include an analog integrated circuit, wherein the adjustment to the receiver gain is an adjustment to a reference voltage in the analog integrated circuit. The GPS receiver may also include a baseband GPS processor including a digital gain amplifier, wherein the adjustment to the receiver gain is an adjustment to a gain the digital gain amplifier and wherein a final baseband signal amplitude inside the baseband GPS processor is adjusted to be approximately a target amplitude.

According to an embodiment of a mobile device, the mobile device has a mobile station modem (MSM) chip, a positioning system signal receiver, a connector to enable positioning system signals to be selectively connected to the RFIC, a circuit for detecting a connection change of a positioning signal receiving antenna to the connector, and a circuit for adjusting a gain applied to the positioning system signals to compensate for the connection change. The positioning system signal receiver may be a GPS signal receiver. When the circuit for detecting a connection change detects a connection of an active antenna, the circuit for adjusting a gain disables the LNA, and when the circuit for detecting a connection change detects a connection of a passive antenna, the circuit for adjusting a gain enables the LNA.

The mobile device may include a low noise amplifier (LNA) to conduct the positioning system signals to the positioning system receiver and the circuit for detecting a connection change detects a connection of an antenna to the connector by monitoring a current between the connector and the LNA. The mobile device may also include a radio frequency integrated circuit (RFIC), and the LNA may be either internal or external to the RFIC.

When the circuit for detecting a change detects a high current between the connector and the LNA, the circuit for detecting a change configures the circuit for adjusting a gain to disable the LNA, and when the circuit for detecting a change detects a low current between the connector and the LNA, the circuit for detecting a change configures the circuit for adjusting a gain to enable the LNA. The circuit for adjusting a gain may comprises a switch to selectively bypass the LNA.

The circuit for adjusting a gain may include a circuit to adjust a reference voltage in the MSM, the gain of a digital gain amplifier in a positioning system processor in the MSM, or the gain of the LNA.

According to an embodiment of a mobile device, means are provided for providing a mobile station modem (MSM) and for receiving positioning system signals. Means are also provided for selectively connecting to a positioning system signal-receiving antenna and for detecting a current required by the positioning system signal antenna. Means are also provided for adjusting a gain applied to the positioning system signals based on an amplitude of the current detected by the means for detecting a current.

The means for adjusting a gain adjusts the gain for an active positioning system signal antenna when the means for detecting a current detects a high current, whereas, a high current may be considered to be “high” if it is above a threshold: e.g. above 1 mA, and adjusts the gain for a passive positioning system signal antenna when the means for detecting a current detects a low current, whereas a low current may be considered to be below 1 mA. Thus, depending on the voltages and impedances used the criteria for a “high” or “low” current threshold may vary.

The mobile device may also include means for providing a low noise amplifier (LNA) for amplifying positioning system signals and means for performing a position location function in response to the positioning system signals. The means for adjusting a gain bypasses the LNA when the means for detecting a current detects a high current. The means for detecting a current comprises means for monitoring a current between the means for selectively connecting to the positioning system signal-receiving antenna and the means for providing an LNA.

The mobile device may also include means for providing a positioning system baseband processor including means for providing a digital amplifier. The means for adjusting a gain comprises means for adjusting a gain of at least one of the group consisting of the means for providing an LNA, means for adjusting a reference voltage in the MSM, and means for providing a digital amplifier.

An embodiment of a method for operating a GPS receiver includes detecting a connection change of an active antenna and when a connection change is detected, adjusting a receiver gain to compensate for the connection change. A LNA is included in a GPS signal path. When the circuit for detecting a connection change detects a disconnection of the active antenna, the circuit for adjusting the receiver gain enables the LNA, and when the circuit for detecting a connection change detects a connection of the active antenna, the circuit for adjusting the receiver gain disables the LNA.

The adjustment to the receiver gain may be an adjustment to a gain of a programmable gain amplifier in a radio frequency integrated circuit (RFIC), a reference voltage in an analog integrated circuit of the GPS receiver, or an adjustment to a gain of a digital gain amplifier in a baseband processor, or any combination of the three adjustments described above, wherein a final baseband signal amplitude inside the baseband processor is adjusted to be approximately a target amplitude.

### BRIEF DESCRIPTION OF THE DRAWINGS

FIG. 1 illustrates a simple block diagram of the connection/disconnection of an active antenna and gain adjustment according to an aspect of the disclosure.

FIG. 2 illustrates the use of a car kit environment according to an aspect of the disclosure.

FIG. 3 illustrates a block diagram of a mobile device having GPS capability, an antenna connection/disconnection detection, and protection capability according to an aspect of the disclosure.

And FIG. 4 illustrates a flow diagram of a method for detecting the connection or disconnection of an active antenna, and for protecting associated circuitry therefrom according to an aspect of the disclosure.

### DETAILED DESCRIPTION

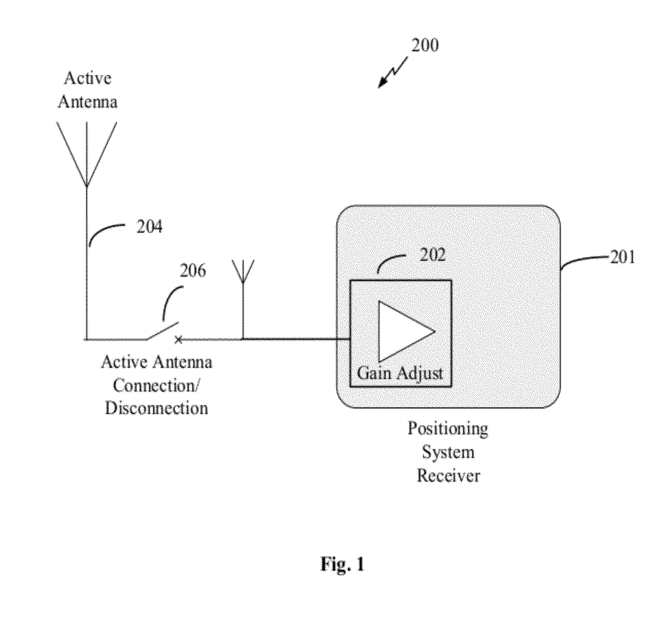

FIG. 1 illustrates a simple block diagram of the connection/disconnection of an active antenna and gain adjustment 200 according to an aspect of the disclosure. Positioning system receiver 201 comprises a position signal gain adjustment 202 and has the ability to detect whether or not an active antenna is connected or disconnect 206. When an active antenna 204 is connected or disconnected 206, i.e. a connection change is made, to the positioning system receiver 201, the gain adjustment 202 adjusts the position signal gain accordingly. An active antenna will add more gain to the position signal, thus, if an active antenna is connected, the gain adjust 202 may lower the gain in the path to compensate for the additional gain received from the active antenna. In conjunction, if an active antenna is disconnected, the gain adjust 202 may raise the gain in the path in order to compensate for the loss of gain from the removal of an active antenna. The detection of an active antenna and gain adjustment may be utilized in various situations and environments. Basically, any environment in which connection to an active antenna for purposes of positioning system location services is desired may be an environment in which the various disclosed embodiments are applicable. For example, positioning system receiver 201 may be a laptop and active antenna 204 may be a built in connector/antenna in a bookstore or restaurant. Another environment may be a “car kit” environment.

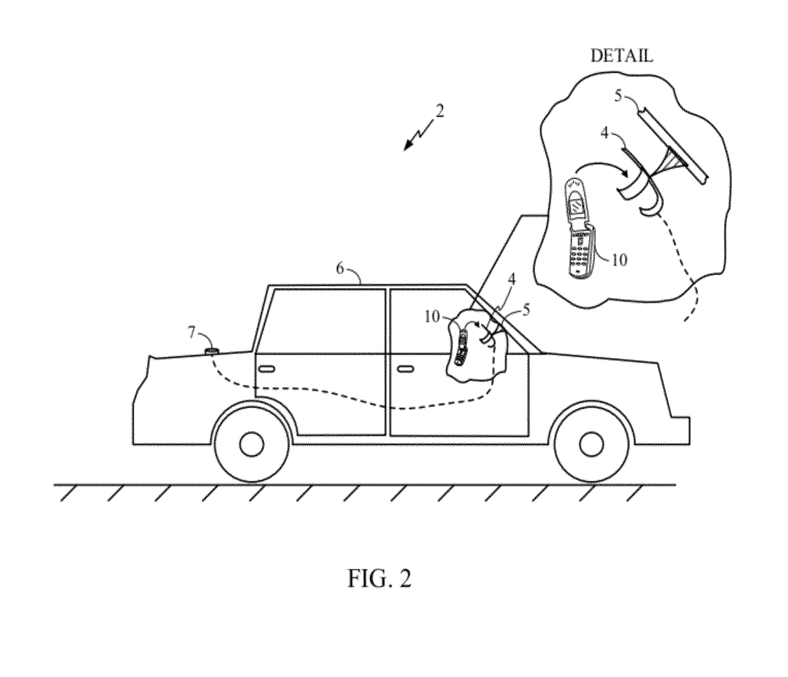

FIG. 2, to which reference is now made, illustrates the use of a car kit environment according to an aspect of the disclosure. In a typical car kit, a bracket or cradle 4 is provided that may be removably attached to the windshield 5 or dashboard of an automobile 6 to removably receive a mobile device 10 to hold the mobile device to enable a user to view the navigation display of the mobile device 10. The cradle 4 is connected to an active antenna 7, which may be mounted at an external location of the automobile 6, such as on the trunk. When the mobile device 10 is carried in the cradle 4, the active antenna 7 is attached to the mobile device 10 to serve as its GPS antenna.

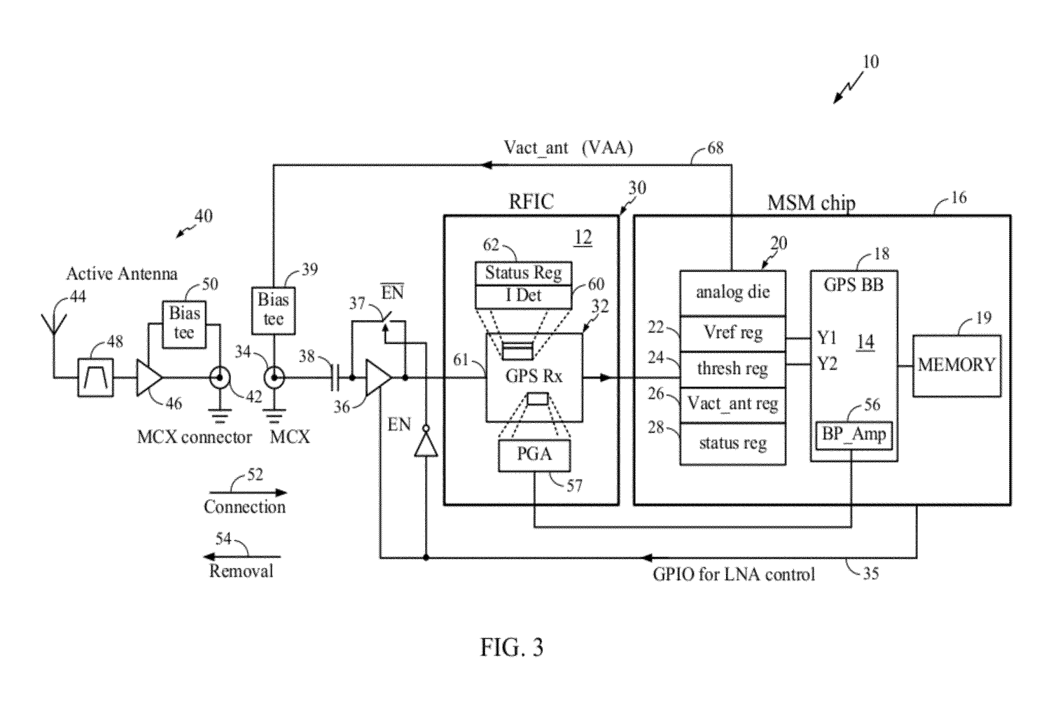

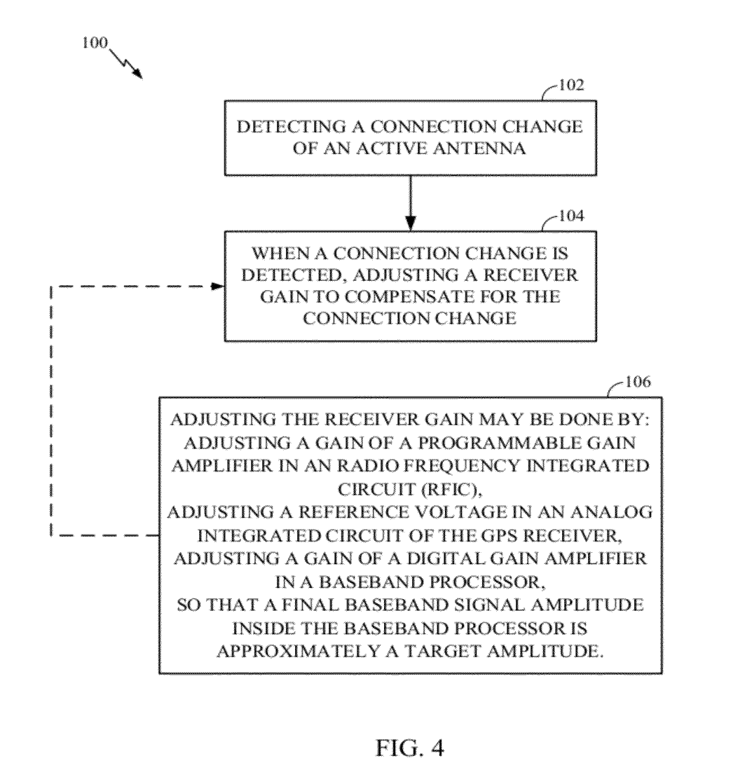

FIG. 3, to which reference is now additionally made, is a block diagram of a mobile device system 10 having a GPS section 12 and having an antenna connection and disconnection detection and protection section 14. The mobile device 10 may be, for example, a mobile station, or the like. “Mobile device” herein refers to position location enabled devices, including SPS or GPS enabled mobile phones, personal navigation devices (PNDs), and includes devices such as a cellular or other wireless communication devices, personal mobile (PCS) devices, personal navigation devices (PND), personal information managers (PIM), PDA, laptop or other suitable mobile devices that are capable of receiving wireless communication and navigation signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all mobile communication devices, including wireless communication devices, computers, laptops, personal digital assistants (PDAs), devices that are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile device.”

In the embodiment shown, the mobile device 10 includes a mobile station modem (MSM) chip 16, which may have, for example, a number of CPU cores, which may include (not shown) a baseband processor to run an operating system, a baseband digital signal processor (DSP) for telephony coding and decoding, an applications processor to run Windows, Linus, or other application, and an applications DSP, to perform media coding and decoding. In addition, in the embodiment illustrated, the MSM chip 16 has a GPS baseband processor 18 that operates in accordance with program contained, for example in a computer readable media, such as memory 19 that is built into the MSM chip 16. It is to be understood that the MSM chip can be a single component or consist of more than one component, or integrated circuit, of mobile device 10.

In general, the digital baseband amplitude (BB_Amplitude) of the GPS baseband processor 18 is in the range of [BB_Ampl_min, BB_Ampl_max], with an ideal theoretical target value of BB_Ampl_target. The range [BB_Ampl_min, BB_Ampl_max] defines the region of operation where the GPS signal strength is acceptable and can be processed by the GPS baseband processor 18 with an acceptable amount of clipping and low signal to noise ratio. The range [BB_Ampl_min, BB_Ampl_max] establishes a dynamic range of the GPS system 12, and is the range where the GPS system 12 works well without degradation. A typical valid baseband amplitude range may be, for example between 100 and 500. This range is design-specific and depends on the design of the GPS baseband processor 18 that processes the digital bit stream. The target value of BB_Ampl_target is a value that allows the optimum operation of the GPS baseband processor 18 that comes from the data path digital design of the particular processor that is used.

The MSM chip 16 has an analog portion 20 to support, among many things, various GPS related functions. In the embodiment shown, for example, the analog portion 20 includes a reference voltage regulator 22, a threshold voltage regulator 24, an active antenna voltage regulator 26, and a status register 28, the functions of which being described in greater detail below.

The mobile device 10 has a radio frequency integrated circuit (RFIC) 30 that contains the GPS section 12, which includes a GPS receiver 32. The GPS receiver receives a GPS signal from a GPS antenna, which may be connected by an MCX connector 34, of the type typically used in GPS or other applications that require broadband capabilities. A LNA 36 amplifies the antenna signal for application to the GPS receiver 32. A capacitor 38 blocks any dc components from the LNA 36. Although the LNA 36, capacitor 38 and bypass switch 37 are shown as internal components to the RFIC 30, they may also be provided externally on an external RF board (not shown).

As described in greater detail below, an enable signal (EN) is derived on line 35 from a general purpose input/output (GPIO) port of the MSM chip 16 to control the LNA 36, and a bypass switch 37 operated by an inverted enable signal is connected to bypass the LNA 36. An active antenna voltage feedback path extends from the MSM 16 to the MCX connector 34 and includes an isolating bias tee 39.

In the embodiment shown in FIG. 3, an active GPS antenna assembly 40 is selectively attachable to the mobile device 10 by an MCX connector 42 that mates with the MCX connector 34. The active GPS antenna assembly 40 may be, for example, an antenna portion of a car kit of the type described above in FIG. 2, or the like.

The active GPS antenna assembly 40 has a GPS antenna 44 that receives GPS signals that are filtered by a bandpass filter 48 and amplified by an amplifier 46. A bias tee 50 provides an isolated feedback path between the MCX connector and the amplifier 46. As indicated, the active GPS antenna assembly 40 can be connected, or inserted, 52 to the GPS receiver 32 or removed 54 therefrom. It should be noted that although an active GPS antenna assembly 40 is described, in some applications a passive GPS antenna may alternatively be used. A passive antenna typically drawsless current than an active antenna. In some embodiments the disconnection of an active antenna may be an equivalent condition to connecting a passive antenna. In fact, whether the GPS antenna is active or passive may be completely unknown to the user; consequently, the circuit 10 operates under either contingency without input from the user.

In operation, the circuit 10 adjusts the available gain of a programmable gain amplifier (PGA) 57 in the RFIC 30, the reference voltage 22 in the analog die 20, and the digital gain amplifier (BP_Amp) 56 in the GPS baseband processor 18 so that the final GPS baseband signal amplitude inside the GPS baseband processor 18 is as close as possible to BB_Ampl_target, described above.

In brief, the amplitude range of the baseband processor 18 needs to be satisfied. This is first done at GPS start up. Subsequently, if an active antenna assembly 40 is connected, the active antenna assembly 40 provides an additional 15 to 25 dB of gain, and the BB_Amplitude signal jumps considerably and saturates the baseband processor 18.

Suppose, for example that the BB_Amplitude is originally adjusted at startup to 250, the target amplitude BB_Ampl_target. If, in a worst case scenario, the mobile device connects into a 25 dB antenna into his GPS receiver 32, absent a gain adjustment, the amplitude of the new baseband amplitude signal, BB_Amplitude, will be BB_Amp_new=10̂(25/20)*250=4450. Clearly, the baseband processor will be saturated, because 4450>>500 (recalling that a valid baseband amplitude range may be between 100 and 500). This kind of heavy saturation will overflow and saturate the digital accumulators in the GPS baseband processor 18 and the GPS signal can no longer be demodulated. Thus, in this scenario, the receive gain is adjusted and the LNA 36, which usually supplies 12 dB of gain, is shut down.

Therefore, when an antenna is connected to the input MCX connector 34, a determination needs to be made whether the antenna is an active or passive antenna. If an active antenna is detected, the initially set gain adjustment needs to be retriggered and reestablished. The mobile device 10 determines whether an active or a passive antenna has been connected to the GPS port by determining that the current through the antenna connector is above a predetermined threshold. This threshold may be, for example, a software configurable value.

The receiver can determine if an active antenna has been connected, because an active antenna needs a bias current to operate; an active antenna typically will drain a bias current of about 5 mA. On the other hand, a passive antenna will not drain any current. Thus, a current detector circuit 60 detects the bias current at the GPS RF port 61, and if the current is above the configurable current threshold, the current detector circuit 60 sets a status register 62, for example, to 1. The GPS RF software periodically (for example, every second) reads that status register 62, and when the read value is 1, turns off the internal LNA 36 and triggers a GPS gain readjustment.

To enable the detection of the connection or disconnection of an active antenna 40, the analog die 20 or a power-management integrated circuit (PMIC) has a programmable output voltage value VAA {for example, 3.5V, 2.5V, or 1.8V} held in register 26 and a programmable threshold value {for example, 1 mA, 2 mA, or 4 mA} held in a threshold register 24. An internal current detector (not shown) detects the current drawn on an output line 68 resulting from the selected programmable output voltage. The analog die 20 also has a status register 28 where a result of a comparison between the current drawn on the VAA line 68 and the threshold is stored. If the current drawn on VAA line 68 is greater than the threshold, the status register 28 is set, for example, to 1. If the current drawn on the VAA line 68 is less than the threshold, the status register 28 is reset, for example, to 0.

The output voltage VAA is connected on line 68 from the analog die 20 via the bias tee 39 (or an RF choke, or the like) to the MCX GPS antenna connector 34 of the mobile device 10 where the active antenna 40 is connected.

The user interface of the mobile device may need to allow the user to configure the value of the active antenna supply voltage VAA, to allow the user to enable or disable this feature, as well as to allow the user to set the current sensing threshold. This configurability may be desirable because there are currently several types of active antennas on the market, and they have slightly different supply voltages, e.g. 3.5V, 2.5V, or 1.8V, but all typically draw about 5 mA of current.

In addition, when an active antenna is connected to the mobile device 10, the RF software turns off and bypasses the LNA 36. The RF software then performs the GPS gain adjustment to readjust the baseband amplitude towards the target value. On the other hand, when an active antenna is disconnected from the mobile device 10, the RF software turns on and switches the LNA 36 into the input RF line. The RF software then performs the GPS gain adjustment to readjust the baseband amplitude towards the target value.

FIG. 4, to which reference is now additionally made, is a flow diagram illustrating an embodiment 100 of a method for operating a GPS receiver for detecting the connection or disconnection of an active antenna, and for protecting associated circuitry therefrom. The method includes detecting a connection change of an active antenna, shown in box 102. When a connection change is detected, a receiver gain is adjusted to compensate for the connection change, shown in box 104.

The adjustment to the receiver gain may be an adjustment to a gain of a programmable gain amplifier in an radio frequency integrated circuit (RFIC), an adjustment to the receiver gain is an adjustment to a reference voltage in an analog integrated circuit of the GPS receiver, an adjustment to a gain of a digital gain amplifier in a baseband processor, or the like, so that a final baseband signal amplitude inside the baseband processor is adjusted to be approximately a target amplitude, as shown in box 106.

Designation that something is “needed,” “required.” or other designation herein does not indicate that the current disclosure applies only to systems in which the “needed” or “required” elements are present (or other limitation due to other designations). These designations refer only to the particular described implementation. Of course, many implementations are possible.

The description herein includes example embodiments; however, other implementations can be used, depending upon the application. For example, the embodiments may be implemented in hardware, firmware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. Herein, the term “control logic” encompasses logic implemented by software, hardware, firmware, or a combination thereof.

For a firmware and/or software implementation, the embodiments may be implemented with modules (e.g., procedures, and functions) that perform the functions described herein. Any machine readable medium tangibly embodying instructions can be used in implementing the embodiments described herein. For example, software codes can be stored in a memory and executed by a processing unit. Memory can be implemented within the processing unit or external to the processing unit. As used herein the term “memory” refers to any type of long term, short term, volatile, nonvolatile, or other storage devices and is not to be limited to any particular type of memory or number of memories, or type of media upon which memory is stored.

If the circuits, circuit functions, and methods herein are implemented in firmware, software, or a combination of firmware and software, they may be stored as instructions, code, data structures, or program steps on a computer-readable medium.

Examples of computer-readable media may take the form of an article of manufacturer, and include physical computer storage media or other medium that can be accessed by a computer. By way of example, such computer-readable media can comprise RAM, ROM, EEPROM, or other solid-state memory device, DVD, Blu-ray, CD-ROM or other optical disk storage, tape, hard disk, floppy disk or other magnetic storage devices, or any other medium that can be used to store desired program code in the form of instructions, code, or data structures.

The circuits, circuit functions, and methods herein may be implemented in conjunction with Wi-Fi, WLAN, or other wireless network environments. In addition to Wi-Fi or WLAN signals, a wireless or mobile device may also receive signals from satellites, which may be from a Global Positioning System (GPS), Galileo, GLONASS, NAVSTAR, QZSS, a system that uses satellites from a combination of these systems, or any SPS developed in the future, each referred to generally herein as a Satellite Positioning System (SPS) or GNSS (Global Navigation Satellite System). The circuits, circuit functions, and methods herein may also be implemented in conjunction with pseudolites, femtocells, or a combination of systems that includes pseudolites or femtocells.

The disclosure may be implemented in conjunction with various wireless communication networks such as a wireless wide area network (WWAN), a wireless local area network (WLAN), a wireless personal area network (WPAN), and so on. The terms “network” and “system” are often used interchangeably. The terms “position” and “location” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

Electrical connections, couplings, and connections have been described with respect to various devices or elements. The connections and couplings may be direct or indirect. A connection between a first and second electrical device may be a direct electrical connection or may be an indirect electrical connection. An indirect electrical connection may include interposed elements that may process the signals from the first electrical device to the second electrical device.

Although embodiments have been described and illustrated with a certain degree of particularity, it should be understood that the present disclosure has been made by way of example only, and that numerous changes in the combination and arrangement of parts may be resorted to without departing from the spirit and scope of the disclosure, as hereinafter claimed.

1. A positioning system signal receiver, comprising:
a circuit for detecting a connection change of an active antenna; and
a circuit for adjusting a receiver gain to compensate for said connection change when a connection change is detected.

2. The positioning system signal receiver of claim 1 further comprising a signal path for a positioning system signal signal from said active antenna, and a low noise amplifier in said signal path.

3. The positioning system signal receiver of claim 2 wherein when said circuit for detecting a connection change detects a disconnection of said active antenna, said circuit for adjusting said receiver gain enables said low noise amplifier.

4. The positioning system signal receiver of claim 2 wherein when said circuit for detecting a connection change detects a connection of said active antenna, said circuit for adjusting said receiver gain disables said low noise amplifier.

5. The positioning system signal receiver of claim 1 further comprising a radio frequency integrated circuit including a programmable gain amplifier, and wherein the adjustment to the receiver gain is an adjustment to a gain said programmable gain amplifier.

6. The positioning system signal receiver of claim 1 further comprising an analog integrated circuit, and wherein the adjustment to the receiver gain is an adjustment to a reference voltage in said analog integrated circuit.

7. The positioning system signal receiver of claim 1 further comprising a baseband processor including a digital gain amplifier and wherein the adjustment to the receiver gain is an adjustment to a gain said digital gain amplifier, wherein a final baseband signal amplitude inside said baseband processor is adjusted to be approximately a target amplitude.

8. The positioning system signal of claim 1, wherein the said active antenna is a Global positioning System antenna, and positioning system signal receiver is a Global Positioning Receiver.

9. A mobile device, comprising:
a mobile station modem (MSM) chip;
a positioning system signal receiver;
a connector to enable positioning system signals to be selectively connected to said positioning system signal receiver;
a circuit for detecting a connection change of a positioning signal receiving antenna to said connector; and
a circuit for adjusting a gain applied to said positioning system signals to compensate for said connection change.

10. The mobile device of claim 9 further comprising a low noise amplifier to conduct said positioning system signals to said positioning system receiver.

11. The mobile device of claim 10 wherein when said circuit for detecting a connection change detects a connection of an active antenna, said circuit for adjusting a gain disables said low noise amplifier.

12. The mobile device of claim 10 wherein when said circuit for detecting a connection change detects at least one selected from the group consisting of: a connection of a passive antenna, and the disconnection of an active antenna; said circuit for adjusting a gain enables said low noise amplifier.

13. The mobile device of claim 10 wherein said circuit for detecting a connection change detects a connection of an active antenna to said connector by monitoring a current between said connector and said low noise amplifier.

14. The mobile device of claim 10 further comprising a radio frequency integrated circuit (RFIC) and wherein when low noise amplifier is internal to said RFIC.

15. The mobile device of claim 10 further comprising a radio frequency integrated circuit (RFIC) and wherein when low noise amplifier is external to said RFIC.

16. The mobile device of claim 10 wherein when said circuit for detecting a connection change detects the current between said connector and said low noise amplifier;
wherein said circuit for detecting compares the detected current to a threshold; if said detected current is equal to or above the threshold, then said circuit for detecting a connection change configures said circuit for adjusting a gain to disable said low noise amplifier;
If said detected current is below the threshold, then said circuit for detecting a connection change configures said circuit for adjusting a gain to enable said low noise amplifier.

17. The mobile device of claim 16 wherein when said circuit for adjusting a gain comprises a switch to selectively bypass said low noise amplifier.

18. The mobile device of claim 9 wherein when said positioning system receiver is a global positioning system (GPS) receiver.

19. The mobile device of claim 9 wherein said circuit for adjusting a gain comprises a circuit to adjust a reference voltage in said MSM.

20. The mobile device of claim 9 further comprising a positioning system baseband processor in said MSM, said positioning system baseband processor comprising a digital gain amplifier, and wherein said circuit for adjusting a gain comprises a circuit to adjust a gain of said digital gain amplifier to be a target amplitude.

21. The mobile device of claim 10 wherein said circuit for adjusting a gain comprises a circuit to adjust a gain of said low noise amplifier.

22. A mobile device, comprising:
means for providing a mobile station modem (MSM);
means for receiving positioning system signals;
means for selectively connecting to a positioning system signal receiving antenna;
means for detecting a current required by said positioning system signal antenna; and
means for adjusting a gain applied to said positioning system signals based on an amplitude of said current detected by said means for detecting a current.

23. The mobile device of claim 22 wherein when said means for adjusting a gain adjusts said gain for an active positioning system signal antenna when said means for detecting a current detects a high current.

24. The mobile device of claim 22 wherein when said means for adjusting a gain adjusts said gain for a passive positioning system signal antenna when said means for detecting a current detects a low current.

25. The mobile device of claim 22 further comprising means for providing a low noise amplifier for amplifying positioning system signals and means for performing a position location function in response to said positioning system signals, and wherein said means for adjusting a gain bypasses said low noise amplifier when said means for detecting a current detects a high current.

26. The mobile device of claim 25 wherein said means for detecting a current comprises means for monitoring a current between said means for selectively connecting to said positioning system signal receiving antenna and said means for providing a low noise amplifier.

27. The mobile device of claim 26 further comprising means for providing a positioning system baseband processor including means for providing a digital amplifier and wherein when said means for adjusting a gain comprises means for adjusting a gain of at least one of the group consisting of said means for providing a low noise amplifier, means for adjusting a reference voltage in said MSM, and means for providing a digital amplifier.

28. The mobile device of claim 22 wherein when said means for receiving positioning system signals comprises means for receiving global positioning system (GPS)signals.

29. A method for operating a GPS receiver, comprising:
detecting a connection change of an active antenna; and
when a connection change is detected, adjusting a receiver gain to compensate for said connection change.

30. The method of claim 29 further comprising a GPS signal path and a low noise amplifier in said signal path.

31. The method of claim 29 wherein when said circuit for detecting a connection change detects a disconnection of said active antenna, said circuit for adjusting said receiver gain enables said low noise amplifier.

32. The method of claim 29 wherein when said circuit for detecting a connection change detects a connection of said active antenna, said circuit for adjusting said receiver gain disables said low noise amplifier.

33. The method of claim 29 wherein the adjustment to the receiver gain is an adjustment to a gain of a programmable gain amplifier in a radio frequency integrated circuit (RFIC).

34. The method of claim 29 wherein the adjustment to the receiver gain is an adjustment to a reference voltage in an analog integrated circuit of said GPS receiver.

35. The method of claim 29 wherein the adjustment to the receiver gain is an adjustment to a gain of a digital gain amplifier in a baseband processor, wherein a final baseband signal amplitude inside said baseband processor is adjusted to be approximately a target amplitude.
